(19) United States
(12) Patent Application Publication
(10) Pub. No.: US 2003/0152250 A1
(43) Pub. Date: Aug. 14, 2003

(54) Personal identification instrument and method therefor

(76) Inventors: Eliahu Pewzner, Modiin-Elit (IL); Moshe zucker, Bnei Brak (IL)

Correspondence Address: Dekel Patent Ltd., Beit HaRof'im, 18 Menuha VeNahala Street, Room 27, Rehovot, IL

(21) Appl. No.: 10/072,867

(22) Filed: Feb. 12, 2002

(51) Int. Cl. G06K 9/00; B42D 15/00; G06K 9/36

(52) U.S. Cl. 382/115; 283/70; 382/232

(57) ABSTRACT

A personal identification instrument (PII) including a naked-eye-viewable image of a legitimate PII owner and an encoded image of said legitimate PII owner disposed on a substrate, wherein the naked-eye-viewable image and the encoded image comprise different aspects of the legitimate PII owner.

### FIELD OF THE INVENTION

The present invention relates generally to personal identification instruments and to methods of their manufacture.

### BACKGROUND OF THE INVENTION

Personal identification instruments are widely used in society, e.g. passports, credit cards, driver's licenses, building passes, airplane tickets and the like. Such instruments are very valuable, and therefore are often illegally fabricated or stolen and altered so that they can be used fraudulently by another person. Such an instrument ideally should be useless in the hands of another person.

In order to make an instrument more difficult to counterfeit or use by another person, it bears the signature and sometimes a photograph of the owner of the instrument. A security guard, cashier, customs agent, and the like, typically verifies the picture visually with the face of the user, sometimes also requests a signature for comparison with the signature on the instrument, and by that means verifies the authenticity of the instrument.

However such instruments are subject to fraud. It is possible to make a fake instrument from a stolen document or card containing a different photograph, matching the fraudulent holder.

U.S. Pat. No. 5,027,113 describes a process and apparatus for making a personal identification instrument, which is subject to machine verification. The identification instrument is first made carrying e.g. indicia and/or a photograph, and deviations from a standard of the outlines of at least some of the indicia (on a magnified scale) are stored in a memory. When an instrument is presented, a machine reads the exact outline of corresponding indicia. Since paper fibers, ink bleeds, etc. result in a different outline than the original, the machine comparing the deviation data with the originally stored outline deviation data can result in the declaration of a fraudulent instrument.

Similarly, for verification of a photograph, the entire photograph is read by a camera. The variation of the distribution of gray levels in the image scanned by the camera, as compared with stored data describing the variation of the distribution of gray levels, stored from the original authentic photograph, can result in detection of a fraudulent instrument.

However, the system of U.S. Pat. No. 5,027,113 requires storage of a large amount of data for each instrument, which becomes very large when photograph data are stored. In addition, each verification station requires access to the stored data. While the data can be stored in a centralized data bank, verification requires the transfer of very large amounts of data along transmission lines from the central data bank to the verification stations. Where there is a continuous flow of persons to be authenticated, for example where many millions of passport-holding persons are subject to verification at any of hundreds of border points spanning very long borders, the cost of using such a system becomes prohibitive.

U.S. Pat. No. 6,292,092 describes another personal identification instrument. The identification instrument is comprised of a substrate, on which are a photograph and/or a personal signature, personal information relating to the legitimate holder of the instrument, and an encrypted machine readable security code. The code is comprised of a combination of digitized personal information and a digitized descriptor of the photograph and/or personal signature. The personal identification instrument may be constructed by acquiring a first digital representation of the picture and/or signature of a legitimate holder of the instrument, extracting first feature data from the digital representation, reading the personal data, combining the feature data with the personal data into a single data sequence and generating a security code by encrypting the sequence with a secret key, and affixing the security code to the instrument.

However, the personal identification instrument of U.S. Pat. No. 6,292,092 comprises a data storage area that may store only descriptors derived from some kind of picture or image (e.g., face of the person) or signature or image of a signature. In order to identify the person bearing the personal identification instrument, the picture or signature must also be printed on the instrument so as to be viewable by the naked eye. In addition, U.S. Pat. No. 6,292,092 does not describe a method for storing a full color image in an encrypted machine readable code.

### SUMMARY OF THE PRESENT INVENTION

The present invention seeks to provide an improved personal identification instrument (PII). The PII of the present invention may have extremely high security, and may obviate the need for storing large amounts of data at a central location. A verification station for verifying the PII may simply include a processor capable of processing an algorithm, and a scanner for scanning the instrument and reading data from the instrument into the processor.

The PII of the present invention may be printed on an extremely inexpensive substrate, such as but not limited to, paper, cardboard, MYLAR or some other kind of plastic. The inexpensive substrate and inexpensive direct printing of images thereon may enable issuance of PIIs in situations that heretofore were too expensive or time-consuming for identification instruments. The invention also may enable frequent changes of previously issued PIIs. The PII of the present invention may be easily distributed to authorized users, and may even be sent by e-mail or fax. The PII of the present invention may be used as a ticket for many applications, such as but not limited to, concerts, movies, buses, trains, airplanes, or army reserve duty.

The PII of the present invention may include an encoded (or enciphered or encrypted—all these terms and similar or equivalent terms being used interchangeably throughout herein) image that comprises the full-color, black-and-white or grayscale picture of the legitimate PII owner. This means that the PII does not need to include the real naked-eye-viewable picture or signature of the legitimate bearer of the PII. This significantly increases the difficulty to forge the PII, since the forger does not know beforehand what information is encoded in the encoded image, and does not know the true picture or signature of the legitimate PII owner. In accordance with another embodiment of the present invention, the naked-eye-viewable image of the legitimate PII owner may be added to the encoded image on the PII, wherein the naked-eye-viewable image and the encoded image are different. For example, the images may be two photographs of the same legitimate owner from two different angles. This embodiment may increase the security of the PII, since it may mislead a would-be forger.

Another advantage of the present invention is the possibility of providing privacy to the legitimate PII owner. Since, in one embodiment, the PII may bear only picture information, such as the face of the legitimate holder, other personal data related to the legitimate owner (e.g., identification number, credit card number, etc.) cannot be acquired at the identification terminal.

The system of the invention may provide privacy to the PII holder even if personal information is printed on the substrate. For example, since there is no need for a connection between a main database and a verification station, the verification station may check the authentication of the PII and provide authorization for the legitimate owner without any need for storing information about the PII owner in a database at the verification station.

The present invention may be used to great advantage at a facility with permanent personnel and guests. The permanent personnel may be issued regular plastic substrate PIIs, while the guests may be issued inexpensive paper PIIs according to the present invention. Accordingly, as opposed to the prior art wherein guests are issued non-picture generic IDs, in the present invention, guests may be quickly and inexpensively issued IDs with identifying pictures.

The present invention may also be used to great advantage at facilities that require temporary identification, such as but not limited to, entrance tickets to sports events or concerts or army bases.

### BRIEF DESCRIPTION OF THE DRAWINGS

The present invention will be understood and appreciated more fully from the following detailed description taken in conjunction with the drawings in which:

FIG. 1 is a simplified pictorial illustration of a personal identification instrument (PII), constructed and operative in accordance with a preferred embodiment of the present invention;

FIG. 2 is a simplified pictorial illustration of a PII, constructed and operative in accordance with a preferred embodiment of the present invention, comprising different naked-eye-viewable images and encoded images on the PII;

FIGS. 3A-3C are simplified pictorial illustrations of PIIs, comprising different combinations of encoded and non-encoded images, constructed and operative in accordance with different embodiments of the present invention, wherein FIG. 3A is a simplified illustration of a PII comprising two pictures of a legitimate owner of the PII from two different angles, FIG. 3B is a simplified illustration of a PII wherein the naked-eye-viewable image may be the legitimate PII owner's signature and the encoded image may be the photograph image of the legitimate holder, and FIG. 3C is a simplified illustration of a PII comprising a traveler's check; and

FIG. 4 is a simplified flow chart of a method for encoding a picture and printing it on a substrate, in accordance with a preferred embodiment of the present invention.

### DETAILED DESCRIPTION OF PREFERRED EMBODIMENTS

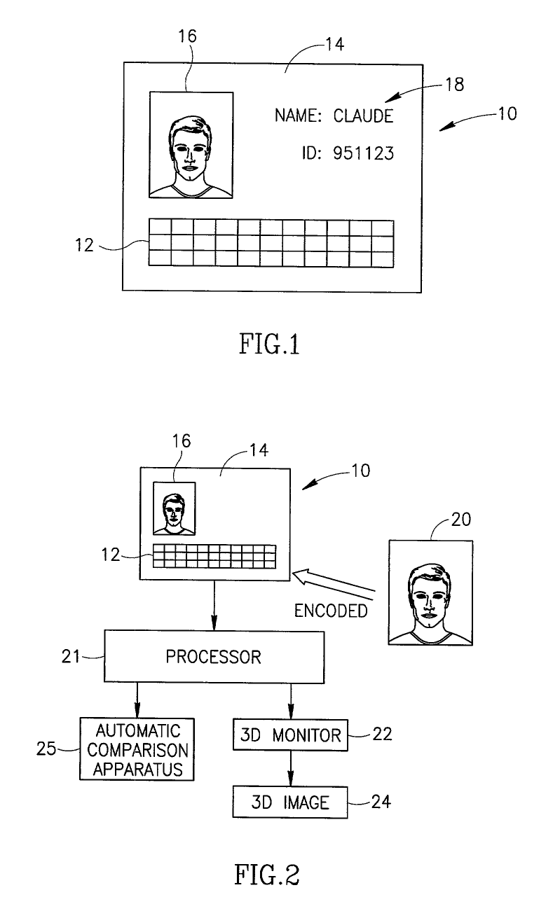

Reference is now made to FIG. 1, which illustrates a personal identification instrument (PII) 10, constructed and operative in accordance with a preferred embodiment of the present invention. The PII 10 may comprise an encoded image 12 disposed (e.g., printed) on an inexpensive substrate 14 (e.g., paper, carton, cardboard, plastic, etc.). The encoded image 12 may appear to the naked eye as a random assembly of full-color, black-and-white or grayscale points or blocks. The encoded image may comprise encoded color, black-and-white or grayscale pictures (not necessarily a reduced descriptor), and optionally some additional information relating to a legitimate PII holder, such as but not limited to, personal identification information, personal signature or biometric information. This additional information may be stored on the encoded image in the form of encoded alphanumeric data or in the form of an encoded picture of such information as photographed or scanned from a paper or other substrate. Additionally or alternatively, this additional information may be printed on the PII as a naked-eye-viewable information image 16 and/or readable characters 18.

Reference is now made to FIG. 2. In accordance with another embodiment of the present invention, the naked-eye-viewable image of the legitimate PII owner may be added to the encoded image on the PII, wherein the naked-eye-viewable image and the encoded image are different, that is, comprise different aspects of the legitimate PII owner.

For example, the images may comprise images formed from two pictures (16 and 20) photographed from two slightly different places. Two such photographs may enable formation of a 3D image of the legitimate PII owner.

The two images may be correctly processed by a processor 21 and displayed on a three-dimensional monitor 22 (such as the model 2015XLS from Dimensions Technologies Inc., Rochester N.Y.) to provide a three-dimensional image 24 of the legitimate PII holder. The three-dimensional image of the legitimate PII holder may be of better quality than a two-dimensional image printed on regular identification cards, thereby possibly providing better recognition of the legitimate holder with better confidence. For example, if the naked-eye-viewable image and the encoded image are different from the genuine images, the security personnel at the identification station may notice a blurred 3D image, indicating a forgery. The system may comprise automatic comparison apparatus 25 (software or hardware), which compares the two images and decides if they belong to the same person. The security personnel or automatic comparison apparatus may also check the correlation between the 3D image on the PII and the person applying for entrance.

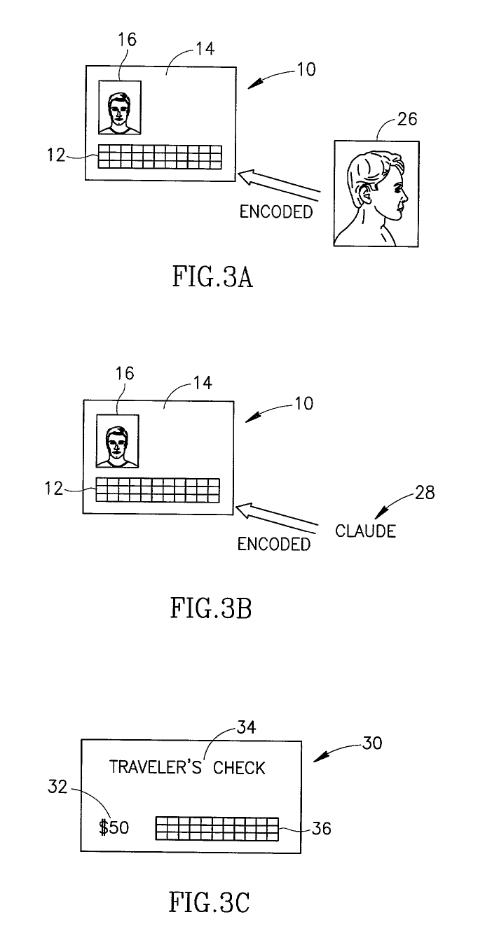

Another example is now described with reference to FIGS. 3A-3C. The images may be two noticeably different photographs (16 and 26) of the same legitimate owner. For example, the two different pictures may be from two different angles, or front and side views of the legitimate owner (FIG. 3A). As another example, the images may comprise different kinds of information. For example, the naked-eye-viewable image may comprise the legitimate PII owner's signature or personal data 28, while the encoded image may be the photograph image of the holder, or vice versa (FIG. 3B). As yet another example, the method of the invention may be useful for a traveler's check 30, wherein the amount of the check 32 is printed in normal, naked-eye-viewable letters on a substrate 34, while the check substrate 34 comprises the encoded image 36 of the face of the legitimate owner of the traveler's check (FIG. 3C). Alternatively, the check value may be encoded while the image of the legitimate owner may be naked-eye-viewable.

One method that may be used to print the images on the substrate is the use of groups of black and white dots. The group of dots represents the image information along with additional error code dots. This group of black and white dots includes all information necessary for image or file reconstruction. The image may then be decoded and converted to a normal image at the distant location. One problem of this method is the large amount of printable area needed in order to incorporate such a large number of dots. For example, a 24-bit color picture comprises three 8-bit colors (RGB—red, green and blue). Accordingly, in order to represent one color (red, green or blue), 256 levels (2⁸) of black and white points may be needed. Thus, the black-and-white dot representation may occupy a much larger area than the original 24-bit color or gray scale image. As a result of this problem, the abovementioned U.S. Pat. No. 6,292,092 may save only some kind of descriptor in the encoded area rather then the image itself, since storing the full-color image by prior art techniques is not possible on the limited space available on certain PII substrates, which are of the size of a business card.

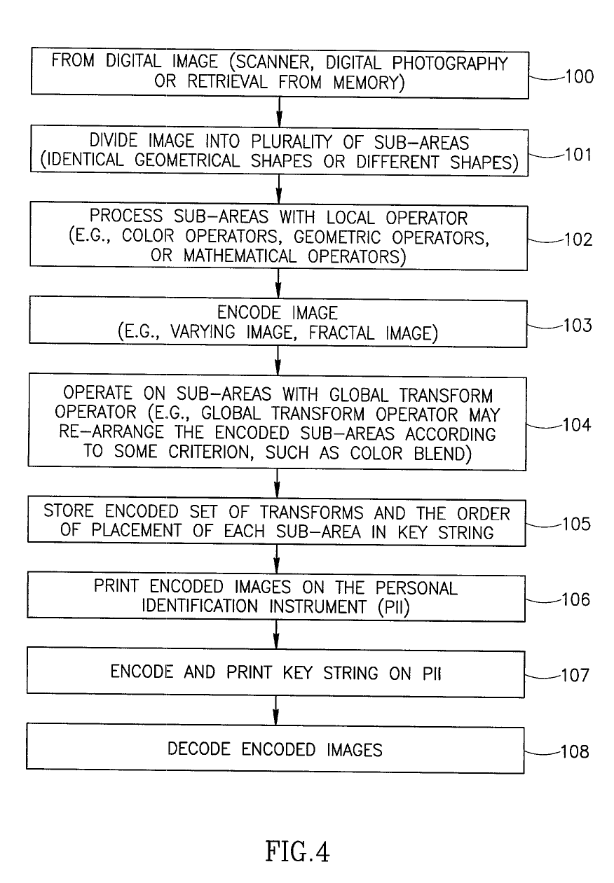

Reference is now made to FIG. 4, which illustrates a method for encoding a picture (e.g., a full 24-bit color picture) and printing it on a substrate (e.g., a small area of the substrate), in accordance with an embodiment of the present invention. This method enables encoding and printing the encoded image on a substrate such as paper, wherein the encoded picture may comprise a full-color image that consumes about the same area of an un-encoded, original image.

The method may comprise scanning or digitally photographing a picture to form a digital image of a person, or retrieving such a digital image from a memory (step 100). The digital image may be divided into several sub-areas (step 101). The sub-areas may comprise identical geometrical shapes, such as but not limited to, squares, triangles, or polygons, or alternatively, may comprise different shapes. The sub-areas may then be processed with a local operator or set of several operators (step 102). An operator is defined as any function applicable to the sub-area, such as but not limited to, color operators (e.g., color inverse transform, or tint, hue or saturation modification), geometric operators (e.g., left-to-right flip, upside down flip, mirror image, rotation, and the like) and mathematical operators (e.g., Boolean operators, such as but not limited to, AND, OR and NOR). This forms an encoded image (step 103).

The abovementioned mathematical operators may be applied on the sub-areas and some auxiliary image. The auxiliary image may comprise all or a portion of the sub-area, such as the background or a portion thereof. The auxiliary image may comprise a varying image (e.g., the image color may change from left to right according to some linear or quadratic function, for example). The auxiliary image may comprise a fractal image, such as but not limited to, a fractal in accordance with a Julia or Mandelbrot set. The fractal image may be generated by some numerical input, which may be simple numbers storable on the PII in printed form such as an OCR code (e.g., bar code). The fractal images may be very sensitive to the initial values of the inputs. Accordingly, even the slightest change in the initial value of the inputs may cause regeneration of an erroneous image, thereby increasing the security of the system. (The hardware and/or software used for decoding may accordingly recognize the numerical strings or other encoded feature in the encoded image in order to decode the image.)

After operating on the sub-areas with one or more operators, the sub-areas may be further operated on by a global transform operator (step 104). The global transform operator may re-arrange the encoded sub-areas according to some criterion, such as color blend. As an illustrative non-limiting example only, a first sub-area may be selected randomly. A first set of operators may be applied to the first sub-area. Based upon some chosen color similarity factor, the global operator may select the sub-area that has a color near its border that best matches a border color of the first sub-area. The selected sub-area may then be placed next to the first sub-area, just like a jigsaw puzzle. The set of transforms and the order of placement of each sub-area may be stored in an encoded key string (step 105). The encoded color images may be printed on the PII by a color printer (step 106), and the key string may be encoded and printed on the PII as OCR alphanumeric characters (step 107). The key string may be encoded by any standard method.

The global transform operators may thus mix or rearrange the discrete sub-areas into a new encoded picture. Different global transform operators may be applied, depending on the desired complexity of the encoding. The global transform operators may determine which kind of local operator should be applied to a specific sub-area. For example, if the main target of the global transform operator is to achieve smooth coloration of the encoded image, then the global transform operator may determine whether the next added sub-area should be treated by a color inverse operator or by an upside down operator or both.

Alternatively, the process of dividing the image into sub-areas, applying local operator(s) and finally applying global operator(s) in order to mix areas, may be accomplished with fewer steps. For example, a full transform may be applied on the original image. The full transform may comprise a large operator that transforms the original image with different methods in different parts of the image. For example, in the case of mathematical operators, the full transform may perform OR on the left side of the image with some auxiliary image, whereas on the right side, perform XOR with the same or another auxiliary image. The full transform may thus act as a kind of global operator that divides the image into sub-areas and applies local operator(s) in one step. Thus, there may be several types of global operators, which may be applied one after another.

Decoding the encoded image is preferably the reverse process of the above-described encoding process (step 108).

It will be appreciated by person skilled in the art that the present invention is not limited by what has been particularly shown and described herein above. Rather the scope of the present invention is defined only by the claims that follow:

What is claimed is:

1. A personal identification instrument (PII) comprising:
a naked-eye-viewable image of a legitimate PII owner and an encoded image of said legitimate PII owner disposed on a substrate, wherein said naked-eye-viewable image and said encoded image comprise different aspects of said legitimate PII owner.

2. The PII according to claim 1 wherein said naked-eye-viewable image and said encoded image comprise images formed from two pictures photographed from two different places.

3. The PII according to claim 1 wherein said naked-eye-viewable image and said encoded image comprise images formed from two pictures photographed from two different angles.

4. The PII according to claim 1 wherein said naked-eye-viewable image and said encoded image comprise images that comprise different kinds of information.

5. The PII according to claim 4 wherein said different kinds of information comprise at least one of said legitimate PII owner's signature, said legitimate PII owner's personal data, and said legitimate PII owner's personal photograph image.

6. The PII according to claim 1 and further comprising a processor adapted to process said naked-eye-viewable image and said encoded image.

7. The PII according to claim 6 and further comprising a three-dimensional monitor adapted to receive processed information from said processor and provide a three-dimensional image of said legitimate PII holder.

8. The PII according to claim 1 and further comprising automatic comparison apparatus adapted to compare said naked-eye-viewable image and said encoded image and decides if said naked-eye-viewable image and said encoded image belong to the same person.

9. A traveler's check comprising:
a naked-eye-viewable image of a legitimate traveler's check owner and an encoded image of said legitimate traveler's check owner disposed on a substrate.

10. The traveler's check according to claim 9, wherein said naked-eye-viewable image and said encoded image comprise different aspects of said legitimate traveler's check owner.

11. A method for personal identification comprising:
forming a digital image of a person;
dividing said digital image into a plurality of sub-areas;
processing said sub-areas to form an encoded image; and
disposing said encoded images on a substrate.

12. The method according to claim 11 wherein said dividing comprises dividing said digital image into a plurality of sub-areas having identical geometrical shapes.

13. The method according to claim 11 wherein said dividing comprises dividing said digital image into a plurality of sub-areas having different shapes.

14. The method according to claim 11 wherein said processing comprises processing said sub-areas with at least one of a color operator, geometric operator, and a mathematical operator.

15. The method according to claim 11 wherein said processing comprises processing said sub-areas to form an encoded image that comprises a varying image.

16. The method according to claim 11 wherein said processing comprises using a mathematical operator to process said sub-areas together with an auxiliary image to form an encoded image.

17. The method according to claim 11 and further comprising operating on said sub-areas with a global transform operator.

18. The method according to claim 17 wherein said operating comprises re-arranging said sub-areas according to a criterion.

19. The method according to claim 18 and further comprising storing information related to said processing in a key string.

20. The method according to claim 11 and further comprising decoding said encoded images.
